(19) United States
(12) Patent Application Publication
(10) Pub. No.: US 2018/0231378 A1
(43) Pub. Date: Aug. 16, 2018

(54) APPARATUS AND METHOD FOR OBTAINING DEPTH INFORMATION USING DIGITAL MICRO-MIRROR DEVICE

(71) Applicant: ELECTRONICS AND TELECOMMUNICATIONS RESEARCH INSTITUTE, Daejeon (KR)

(72) Inventor: Jae Han KIM, Gwacheon (KR)

(21) Appl. No.: 15/870,704

(22) Filed: Jan. 12, 2018

(30) Foreign Application Priority Data
Feb. 10, 2017 (KR) 10-2017-0018854

(51) Int. Cl. G01C 3/12; G01C 3/08

(52) U.S. Cl. CPC G01C 3/12; G01C 3/08

(57) ABSTRACT

A depth information acquiring apparatus using a digital micro-mirror device (DMD), and a method thereof are provided. The depth information obtaining apparatus includes: a first digital micro-mirror device (DMD) that generates first line light and irradiates the first line light to an object; a second DMD that receives second line light reflected from the object and reflects light corresponding to the second line light; a sensor that senses light reflected by the second DMD; and a controller that controls operations of the first and second DMDs, and calculates depth information of the object by using information with respect to light sensed by the sensor.

### CROSS-REFERENCE TO RELATED APPLICATION

This application claims priority to and the benefit of Korean Patent Application No. 10-2017-0018854 filed in the Korean Intellectual Property Office on Feb. 10, 2017, the entire contents of which are incorporated herein by reference.

### BACKGROUND OF THE INVENTION

### (a) Field of the Invention

The present invention relates to an apparatus for obtaining depth information using a digital micro-mirror device, and a method thereof.

### (b) Description of the Related Art

Depth information is useful information that is utilized in various application fields such as a 3D movie, a 3D TV, 3D graphics, holography, an autonomous driving unmanned vehicle, a guided weapon, a robot visual device, factory automation, user interaction, a game, and the like.

A method for obtaining depth information can be broadly classified into a direct measurement method and an indirect measurement method. The direct measurement method includes a calculation method using triangulation and a time-of-flight measurement method. The indirect measurement method includes a method using focusing information, a shadow analysis method using lighting, and a moiré method. The most accurate and useful method is the direct measurement method. A stereoscopic method is a passive method of the direct measurement method, and a structured light illumination method is an active method of the direction measurement method. The stereoscopic method finds a corresponding point using at least two sheets of images, calculates binocular disparity from the corresponding point, and calculates a depth by triangulation method. However, the passive method has a drawback of imperfection in passive selection of a corresponding point.

The structured light illumination method uses a light pattern having a predetermined structure in order to overcome such an imperfection in the passive selection of the corresponding point. Such a method mostly uses a straight-line type of light pattern, and an image is obtained through the illumination light pattern, and then an illumination angle of a light source and a main angle viewed by each pixel of a camera are applied to the triangulation method such that depth information can be obtained.

As the structured light illumination method, an illumination method that scans light in the form of a vertical stripe from left to right or from right to left is mostly used. In such a case, a polygon mirror or a rotation mirror that rotates a mirror mounted to a vertical axis or a horizontal axis or a Galvano mirror is used as a mechanical device in the structured light illumination method.

However, such a conventional method has problems of high volume, generation of noise during rotation of the mirror, and limitation in high-speed scanning. In addition, an optical axis of the rotation mirror cannot be easily aligned, and an error may occur. The thickness of a projected optical scan line may be changed or intensity of reflected light is changed depending on depth so that image may not be clear when reflected light is obtained through a camera.

In addition, when scanned laser light is reflected at the surface of the object, a camera for obtaining an image of a laser beam or a dedicated sensor array is required. In this case, a large amount of image data to be processed is required and when a dedicated sensor, which is separately manufactured for distance information processing, is used, production cost is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus for obtaining depth information by using a digital micro-mirror device (DMD), and a method thereof.

According to an exemplary embodiment of the present invention, a depth information acquiring apparatus can be provided. The depth information obtaining apparatus includes: a first digital micro-mirror device (DMD) that generates a first line light and irradiates the first line light to an object; a second DMD that receives a second line light reflected from the object and reflects light corresponding to the second line light; a sensor that senses light reflected by the second DMD; and a controller that controls operations of the first and second DMDs, and calculates depth information of the object by using information with respect to light sensed by the sensor.

The first DMD may include a plurality of element mirrors, and element mirrors arranged in one column among the plurality of element mirrors may be simultaneously driven such that the first line light is generated.

The second DMD may include a plurality of element mirrors, and the plurality of element mirrors may be driven one by one to reflect light corresponding to the second line light to the sensor.

For a first period during which the first line light is irradiated to the object, all element mirrors of the second DMD may be driven one by one to reflect light corresponding to the second line light to the sensor.

The controller may calculate the depth information by using an irradiation angle of the first line light to the object and a location at which the second line light is received at the second DMD.

The second DMD may include a plurality of element mirrors arranged in n columns and m rows, and the controller may sequentially drive the element mirrors of a predetermined column that is smaller than an m-th column and then may detect all light from n element mirrors, and may omit driving of other columns excluding the predetermined column.

The second DMD may include a plurality of element mirrors, and when light is detected from one of the plurality of element mirrors while sequentially driving element mirrors arranged in the first row, the controller may omit driving of the rest of the element mirrors in the first row and may sequentially drive element mirrors arranged in the second row.

The depth information obtaining apparatus may further include an optical system that is disposed between the first DMD and the second DMD and focuses the first line light to the second DMD.

The depth information obtaining apparatus may further include an optical system that is disposed between the second DMD and the sensor and focuses light reflected by the second DMD to the sensor.

According to another exemplary embodiment of the present invention, a method for obtaining depth information of an object by irradiating a first line light to the object may be provided. The method includes: generating the first line light and irradiating the first line light to the object by using the first digital micro-mirror device (DMD); reflecting a second line light reflected from the object by using the second DMD; detecting a location where the second line light is reflected in the second DMD; and calculating the depth information by using the detected location.

The detecting the location may include sensing light reflected by the second DMD; and detecting the location by using a driving time of the second DMD and the sensed light.

The first DMD may include a plurality of element mirrors, and the irradiating the first line light may include generating the first line light by simultaneously driving element mirrors arranged in one column among the plurality of element mirrors and irradiating the first line light to the object.

The second DMD may include a plurality of element mirrors, and the reflecting the second line light may include reflecting light corresponding to the second line light by driving the plurality of element mirrors one by one.

For a first period during which the first line light is irradiated to the object, all element mirrors of the second DMD may be driven one by one to reflect light corresponding to the second line light.

The calculating the depth information may calculate the depth information by using an angle at which the first line light is irradiated to the object and the detected location.

According to still another exemplary embodiment of a depth information obtaining apparatus can be provided. The depth information obtaining apparatus includes: a first digital micro-mirror device (DMD) that includes a plurality of first element mirrors and transmits a first line light to an object; a second DMD that includes a plurality of second element mirrors, receives a second line light reflected from the object, and reflects light corresponding to the second line light; a sensor that senses light reflected by the second DMD; and a controller that controls the first line light to be generated by simultaneously driving element mirrors arranged in one column among the plurality of first element mirrors for a first period, and controls light corresponding to the second line light to be reflected to the sensor by driving the plurality of second element mirrors one by one, wherein the controller calculates depth information of the object by using information with respect to light sensed by the sensor

The controller may calculate the depth information by using an irradiation angle of the first line light to the object and a location at which the second line light is received at the plurality of second element mirrors.

According to the exemplary embodiments of the present invention, since a DMD is used as a means to generate light line light rather than using a galvano mirror, high mechanical stability can be provided and no rotation noise is generated.

According to the exemplary embodiments of the present invention, a DMD is used as a means for receiving reflection light so that a certain type of reflected light can be obtained.

According to the exemplary embodiments of the present invention, since the DMD is used, the entire size of the depth information obtaining apparatus can be reduced and depth information can be stably obtained.

In addition, according to the exemplary embodiments of the present invention, the depth information can be obtained by using two DMDs and one simple sensor, thereby simply acquiring depth information.

### BRIEF DESCRIPTION OF THE DRAWINGS

FIG. 1 shows a depth information obtaining apparatus according to an exemplary embodiment of the present invention.

FIG. 2 shows a method for a transmission DMD to generate line light according to the exemplary embodiment of the present invention.

FIG. 3 shows operation pulses of a transmission DMD and a receiving DMD according to the exemplary embodiment of the present invention.

FIG. 4 shows a sequential driving method of the receiving DMD according to the exemplary embodiment of the present invention.

FIG. 5 shows a geometric structure of the depth information obtaining apparatus for description of a depth information calculation method of a controller according to the exemplary embodiment of the present invention.

FIG. 6 shows a sequential driving method of a receiving DMD according to another exemplary embodiment of the present invention.

FIG. 7A and FIG. 7B respectively show a sequential driving method of a receiving DVD according to still another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Hereinafter, a depth information obtaining apparatus using a digital micro-mirror device, and a method thereof according to an exemplary embodiment of the present invention will be described.

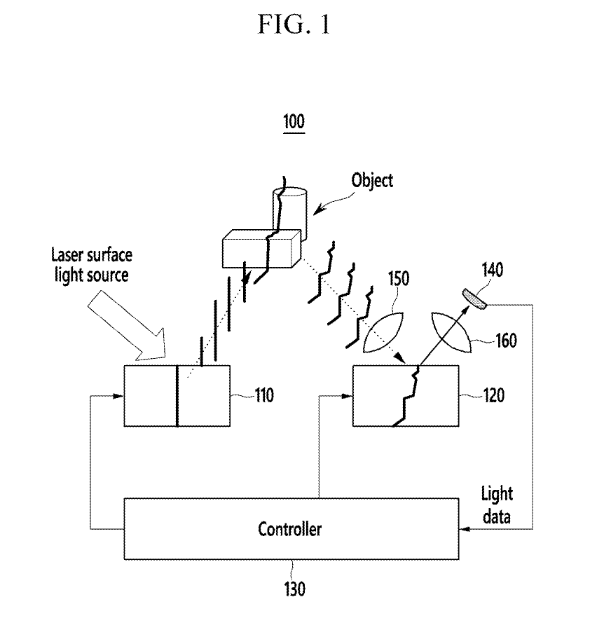

FIG. 1 shows a depth information obtaining apparatus 100 according to an exemplary embodiment of the present invention.

As shown in FIG. 1, the depth information obtaining apparatus 100 according to the exemplary embodiment of the present invention includes a digital micro-mirror device (DMD) for transmission (hereinafter referred to as a transmitting DMD) 110, a DMD for receiving (hereinafter referred to as a receiving DMD) 120, a controller 130, a sensor 140, a first optical system 150, and a second optical system 160.

The transmitting DMD 110 is controlled by the controller 130 and sequentially irradiates (transmits) line light to an object of which a depth needs to be measured. The transmitting DMD 110 is formed of a digital micro-mirror device (DMD).

The DMD is a device of which micro-mirrors are arranged using a semiconductor process and image information of a pixel is controlled by adjusting an angle of each element mirror, and has merits of high contrast, rapid driving speed, inexpensive cost, and the like. One of the plurality of element mirrors arranged in the DMD may have the following three states: flat, on, and off. When no power is applied, the element mirror is in a flat state. An element mirror corresponding to a pixel at a position to be modulated is electrically inclined into a state of (+/−)Ω°. Cases that the element mirror is inclined in the state of (+/−)Ω° respectively correspond to an on state and an off state. The on/off state of each element mirror is programmed such that line light can be generated.

In the exemplary embodiment of the present invention, light from the laser surface light source is wholly irradiated to the transmitting DMD 110, and transmitting DMDs 110 are sequentially turned on per each column such that line light is generated. In this case, the transmitting DMDs 110 are sequentially turned on per column by control of the controller 130.

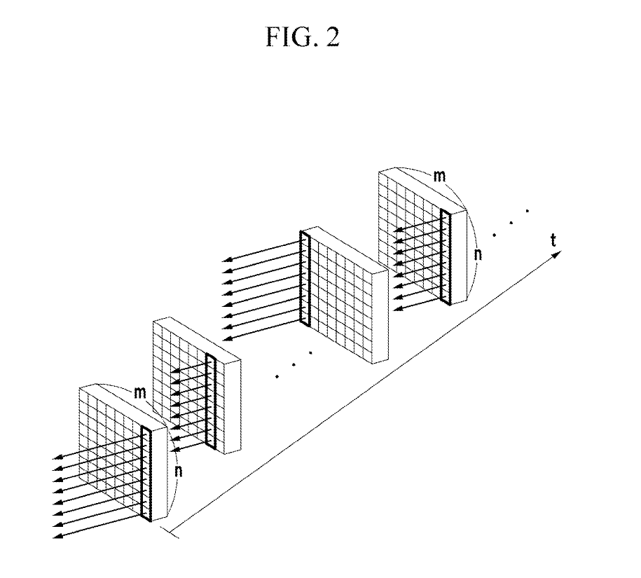

FIG. 2 shows a method for the transmitting DMD 110 according to the exemplary embodiment of the present invention to generate line light. In FIG. 2, m denotes the number of element mirrors in a horizontal axis of the DMD, and n denotes the number of element mirrors in a vertical axis of the DMD.

As shown in FIG. 2, element mirrors arranged in the first column of the transmitting DMD 110 are simultaneously turned on, and then element mirrors arranged in the second column are simultaneously turned on. As described, the transmitting DMD 100 sequentially turns on element mirrors arranged from the first column to the m-th column to thereby sequentially generate line light.

The receiving DMD 120 is controlled by the controller 130, and receives line light reflected from the object and reflects the received line light to the sensor 140. The receiving DMD 120 is also formed of DMDs. If the line light generated in the transmitting DMD 110 is reflected to the object, the line light becomes bent line light depending on surface roughness of the object. Here, the bent line light implies a depth change from a 3-dimensional reference point, and includes depth information. The receiving DMD 120 reflects light corresponding to such bent line light to the sensor 140. In this case, the receiving DMD 120 turns on element mirrors one by one and each turned-on element mirror reflects light to the sensor 140.

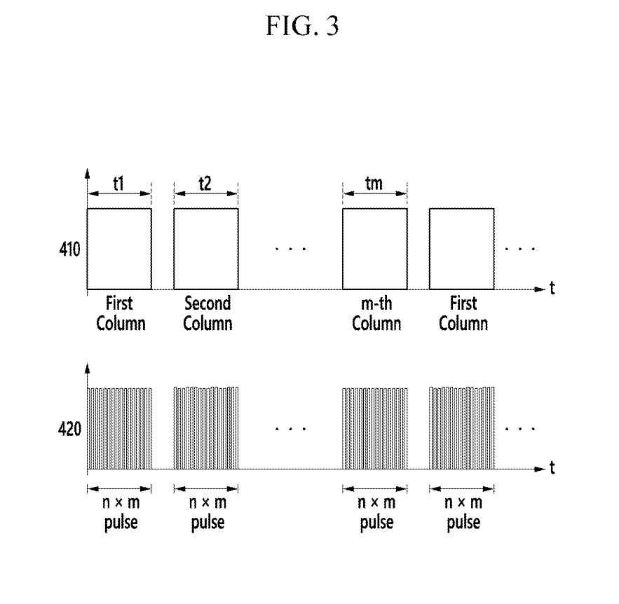

FIG. 3 shows operation pulses of the transmitting DMD 110 and the receiving DMD 120 according to the exemplary embodiment of the present invention. In FIG. 3, reference numeral 410 denotes an operation pulse of the transmitting DMD 110 and reference numeral 420 denotes an operation pulse of the receiving DMD 120.

As shown in FIG. 3, when the operation pulse is simultaneously applied to element mirrors in the first column of the transmitting DMD 110, the operation pulse is sequentially applied to element mirrors of the receiving DMD 120 one by one. That is, during t1 in which the element mirrors of the first column of the transmitting DMD 110 are turned on, all the element mirrors of the receiving DMD 120 are sequentially turned on one by one by n×m pulses. In addition, when the operation pulse is applied to element mirrors of the second column of the transmitting DMD 110, the operation pulse is sequentially applied to the respectively element mirrors of the receiving DMD 120 one by one. That is, during t2 in which the element mirrors of the second column of the transmitting DMD 110 are turned on, all the element mirrors of the receiving DMD 120 are sequentially turned on one by one by n×m pulses. That is, while the transmitting DMD 110 generates one line light and irradiates (transmits) the line light to the object, the receiving DMD 120 turns on all the element mirrors one by one and reflects bent line light to the sensor 140 per each element mirror.

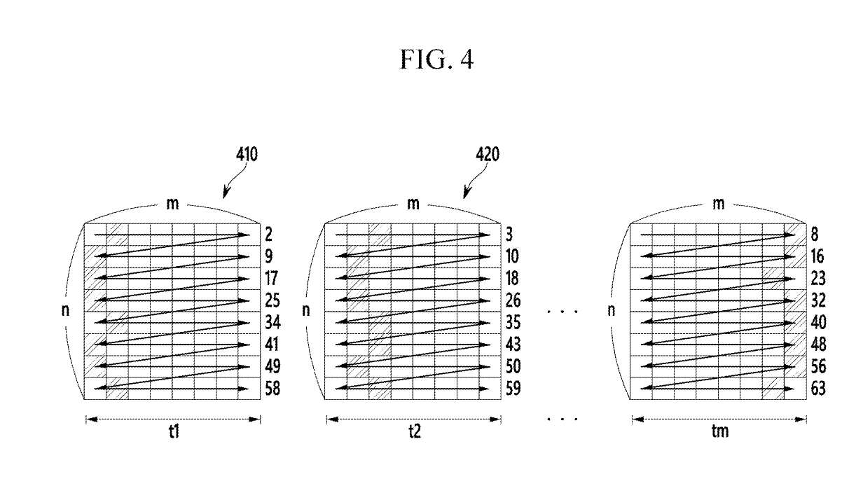

FIG. 4 shows a sequential driving method of the receiving DMD 120 according to the exemplary embodiment of the present invention. In FIG. 4, the shaded portions represent portions corresponding to the bent line light reflected from the object.

As shown in FIG. 4, during t1, the receiving DMD 120 is sequentially driven from the first row to the n-th row such that the element mirrors in the respective rows are sequentially turned on. In this case, when light exists in each element mirror, the light is reflected and then transmitted to the sensor 140. During t1, line light is generated from the first column of the transmitting DMD 110, and the first line light is reflected to the object and is thus incident on the receiving DMD 120. In this case, during t1, the respective element mirrors of the receiving DMD 120 are sequentially turned on and light corresponding to bent line light is reflected to the sensor 140.

During t2, the receiving DMD 120 is sequentially driven from the first row to the n-th row and thus the respective element mirrors are sequentially turned on. In this case, when light exists in each element mirror, the light is reflected to be transmitted to the sensor 140. During t2, line light is generated from the second column of the transmitting DMD 110, and the second line light is reflected to the object and is thus incident on the receiving DMD 120. In this case, during t2, the respective element mirrors of the receiving DMD 120 are sequentially turned on and light corresponding to bent line light is reflected to the sensor 140.

As described, the receiving DMD 120 according to the exemplary embodiment of the present invention sequentially turns on the respective element mirrors so as to detect bent line light.

The sensor 140 senses light reflected by the receiving DMD 120. The sensor 140 may be implemented as a sensor that senses light, such as a photodiode. When sensing light, the sensor 140 transmits data of the sensed light to the controller 130. That is, the sensor 140 according to the exemplary embodiment of the present invention receives light corresponding to bent line light from the receiving DMD 120 and senses the received light, and transmits data of the sensed light to the controller 130. The controller 130 obtains the location of the receiving element mirror of the receiving DMD 120 by checking the counter number of the operation pulse using the sensed light data.

Meanwhile, the controller 130 controls operation of the transmitting DMD 110 and operation of the receiving DMD 120. The controller 130 controls sequential driving per column of the transmitting DMD 110, and controls sequential driving of the receiving DMD 120. That is, the controller 130 performs a control operation to control the transmitting DMD 110 and the receiving DMD 120 to operate as shown in FIG. 2 to FIG. 4.

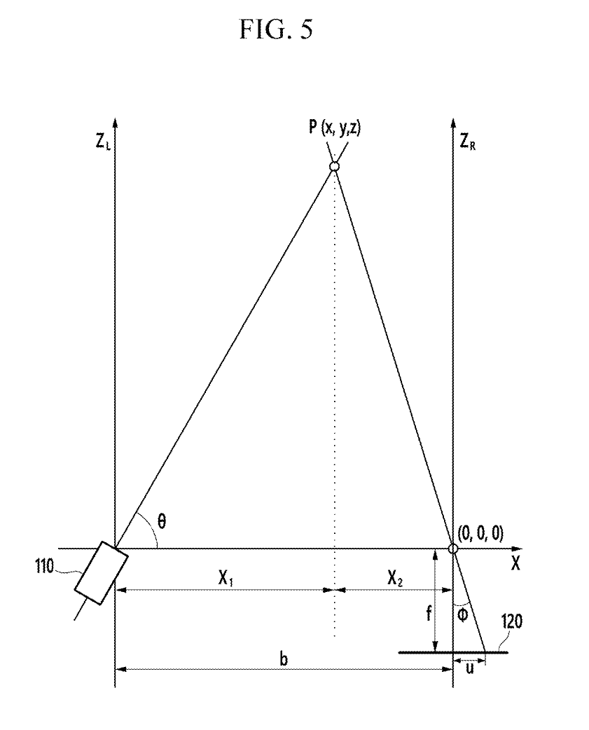

In addition, the controller 130 according to the exemplary embodiment of the present invention receives light data from the sensor 140 and calculates depth information by using the received light data. As described above, the bent line light reflected to the object includes depth information, and the controller 130 calculates depth information by using the light data received from the sensor 140. A depth information calculation method of the controller 130 will be described in detail with reference to FIG. 5.

Meanwhile, as shown in FIG. 1, the depth information obtaining apparatus 100 according to the exemplary embodiment of the present invention includes the first optical system 150 and the second optical system 160.

The first optical system 150 is provided between the object and the receiving DMD 120, and serves to focus bent line light reflected to the object to the receiving DMD 120. In addition, the first optical system 150 also serves to remove noise. The first optical system 150 may be provided as a convex lens and the like.

The second optical system 160 is disposed between the receiving DMD 120 and the sensor 140, and serves to focus light reflected from the receiving DMD 120 to the sensor 140. In addition, the second optical system 160 also serves to remove noise. The second optical system 160 may be provided as a convex lens and the like. In addition, a projection optical system composed of a convex lens or the like may be positioned between the transmitting DMD 110 and the object so that the transmitting DMD 110 can clearly illuminate the object with the line light.

FIG. 5 shows a geometric structure of the depth information obtaining apparatus provided for description of the depth information calculation method of the controller 130 according to the exemplary embodiment of the present invention.

In FIG. 5, P denotes one dot at a surface of a target object in a 3-dimensional space, and (0, 0, 0) denotes a center of the lens of the first optical system 150. b, as a baseline, denotes a distance from the transmitting DMD 110, which is a light source, to the center of the first optical system 150. u denotes a distance from the center point of the receiving DMD 120 to a element mirror of the receiving DMD 120 at which the bent line light is received. f denotes a focal length of the first optical system 150, and θ denotes an angle formed by the line light and the reference line b. In addition, φ denotes an angle formed by each element mirror of the receiving DMD 120 and the reference line b.

When a trigonometric function is applied, tamp is as given in Equation 1.

tan ψ=u/f (Equation 1)

In addition, in FIG. 5, X1 and X2 are respectively as given in Equation 2 and Equation 3.

X1=z·tan(90−θ) (Equation 2)

X2=z·tan (ψ) (Equation 3)

The reference line b is as given in Equation 4.

b=X1+X2 (Equation 4)

When Equation 2 and Equation 3 are put to Equation 4, Equation 5 can be given as follows.

b=z·tan(90−θ)+z·tan (ψ) (Equation 5)

In Equation 5, when Equation 1 is inserted instead of tamp and z is solved, z can be calculated as given in Equation 6.

z=b·f/(u+f cot θ) (Equation 6)

In Equation 6, z is depth information that the controller 130 needs to calculate. In Equation 6, b, f, and θ are values that are predetermined in a setup stage of the depth information obtaining apparatus 100. Thus, the controller 130 calculates depth information only when u that corresponds to the bent line light is obtained in Equation 6.

The controller 130 can obtain u by using light data received from the sensor 140. Since the controller 130 controls the receiving DMD 120, the controller 130 is aware of on-timing of the respective element mirrors of the receiving DMD 120. Accordingly, the controller 130 determines which element mirror receives line light through the timing of the light data received from the sensor 140 and accordingly obtains the value of u.

The method for the controller 130 to calculate the value u will be described in further detail with reference to FIG. 4. During t1, bent line light is seen in the shaded portions of 410 in FIG. 4. During t1, the controller 130 receives light data information corresponding to the bent line light through the sensor 140 while sequentially driving the respective element mirrors of the receiving DMD 120, thereby calculating the value of u. That is, referring to reference numeral 410, the controller 130 is aware of generation of the bent line light in the 2nd, 9th, 17th, 25th, 34th, 41st, 49th, and 58th element mirrors so that the value of u can be calculated therefrom. In addition, referring to reference numeral 420, during t2, the controller 130 is aware of generation of the bent line light in the 3rd, 10th, 18th, 26th, 35th, 43rd, 50th, and 59th element mirrors so that the value of u can be calculated therefrom. The controller 130 calculates depth information (e.g., z) by using the value of u.

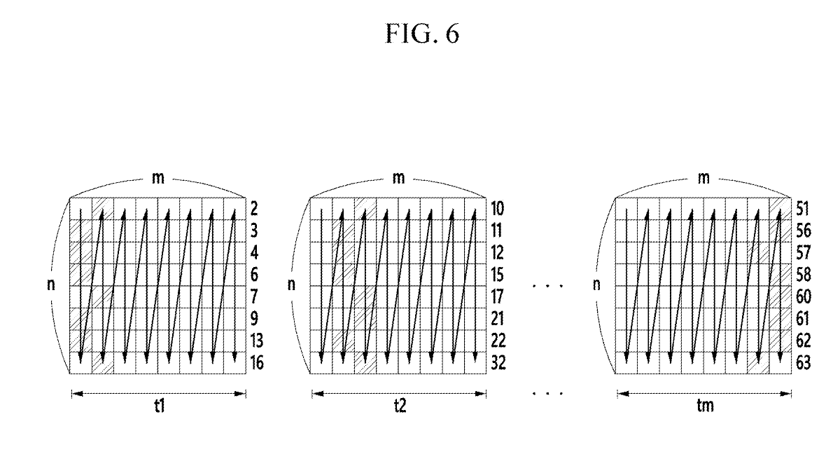

FIG. 6 shows a sequential driving method of a receiving DMD 120 according to another exemplary embodiment of the present invention.

As shown in FIG. 6, the receiving DMD 120 is sequentially driven from the first column to the n-th column unlike the receiving DMD 120 shown in FIG. 4, such that element mirrors can be sequentially turned on. In such a case, the controller 130 detects bent line light from the 2nd, 3rd, 4th, 6th, 7th, 9th, 13th, and 16th element mirrors during t1 and calculates a value of u by using the detected information.

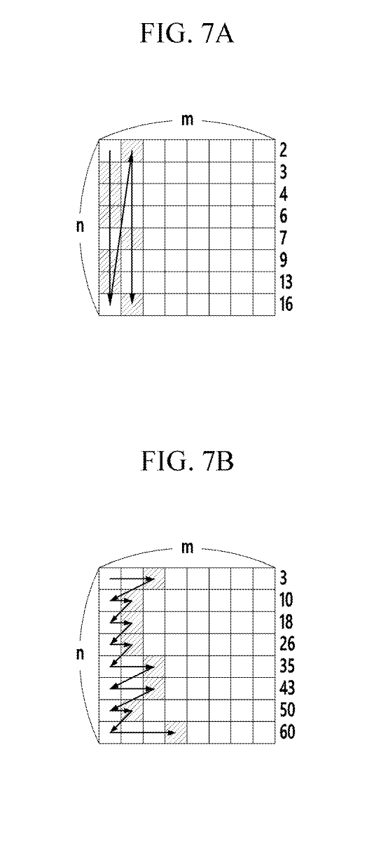

FIG. 7A and FIG. 7B respectively show a sequential driving method of a receiving DMD according to still another exemplary embodiment of the present invention.

FIG. 7A shows a method for promptly detecting bent line light when columns of a receiving DMD are sequentially driven.

As shown in FIG. 7A, element mirrors of the first column of the receiving DMD 120 are sequentially driven from top to bottom such that light is detected from the 2nd, 3rd, 4th, 6th, and 7th element mirrors. In addition, element mirrors of the second column of the receiving DMD 120 are sequentially driven from top to bottom such that light is detected from the 9th, 13th, and 16th element mirrors. Since light detected from the receiving DMD 120 is in the form of a line, no more light detection is needed when all element mirrors of the second column are driven. Accordingly, the controller 130 does not need to drive other columns, thereby saving time consumed for light detection.

FIG. 7B shows a method for promptly detecting bent line light when rows of the receiving DMD are sequentially driven.

As shown in FIG. 7B, element mirrors of the first row of the receiving DMD 120 are sequentially driven from left to right such that light is detected from the third element mirror. Since light detected from the receiving DMD 120 is in the form of a line, no more light is detected from element mirrors subsequent to the third element mirror in the first row. Therefore, element mirrors of the second row are sequentially driven from right to left after light is detected from the third element mirror such that light is detected from the 10th element mirror. Since no more light is detected from the second row after light is detected from the 10th element mirror, no more light is detected from the element mirrors subsequent to the 10th element mirror in the second row. Thus, after light is detected from the 10th element mirror, element mirrors of the third row are sequentially driven from left to right. Through such a method, time consumed to detect light can be further saved.

As described above, the depth information obtaining apparatus according to the exemplary embodiment of the present invention uses a DMD rather than using a galvanometer mirror as means for generating line light, and therefore no rotation noise is generated. The depth information obtaining apparatus according to the exemplary embodiment of the present invention uses a DMD as a means for receiving reflection light so that a certain type of reflected light can be obtained. Meanwhile, according to the exemplary embodiment of the present invention, since the DMD is used, the entire size of the depth information obtaining apparatus can be reduced and depth information can be stably obtained.

In addition, in the exemplary embodiment of the present invention, the depth information can be obtained by using two DMDs and one simple sensor, thereby saving cost.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A depth information obtaining apparatus comprising:
a first digital micro-mirror device (DMD) that generates a first line light and irradiates the first line light to an object;
a second DMD that receives a second line light reflected from the object and reflects light corresponding to the second line light;
a sensor that senses light reflected by the second DMD; and
a controller that controls operations of the first and second DMDs, and calculates depth information of the object by using information with respect to light sensed by the sensor.

2. The depth information obtaining apparatus of claim 1, wherein the first DMD comprises a plurality of element mirrors, and element mirrors arranged in one column among the plurality of element mirrors are simultaneously driven such that the first line light is generated.

3. The depth information obtaining apparatus of claim 1, wherein the second DMD comprises a plurality of element mirrors, and the plurality of element mirrors are driven one by one to reflect light corresponding to the second line light to the sensor.

4. The depth information obtaining apparatus of claim 1, wherein for a first period during which the first line light is irradiated to the object, all element mirrors of the second DMD are driven one by one to reflect light corresponding to the second line light to the sensor.

5. The depth information obtaining apparatus of claim 1, wherein the controller calculates the depth information by using an irradiation angle of the first line light to the object and a location at which the second line light is received at the second DMD.

6. The depth information obtaining apparatus of claim 1, wherein the second DMD comprises a plurality of element mirrors arranged in n columns and m rows, and the controller sequentially drives the element mirrors of a predetermined column that is smaller than an m-th column and then detects all light from n element mirrors, and omits driving of other columns excluding the predetermined column.

7. The depth information obtaining apparatus of claim 1, wherein the second DMD comprises a plurality of element mirrors, and when light is detected from one of the plurality of element mirrors while sequentially driving element mirrors arranged in the first row, the controller omits driving of the rest of the element mirrors in the first row and sequentially drives element mirrors arranged in the second row.

8. The depth information obtaining apparatus of claim 1, further comprising an optical system that is disposed between the first DMD and the second DMD and focuses the first line light to the second DMD.

9. The depth information obtaining apparatus of claim 1, further comprising an optical system that is disposed between the second DMD and the sensor and focuses light reflected by the second DMD to the sensor.

10. A method for obtaining depth information of an object by irradiating a first line light to the object, comprising:
generating the first line light and irradiating the first line light to the object by using the first digital micro-mirror device (DMD);
reflecting a second line light reflected from the object by using the second DMD;
detecting a location where the second line light is reflected in the second DMD; and
calculating the depth information by using the detected location.

11. The method for obtaining the depth information of claim 10, wherein the detecting the location comprises:
sensing light reflected by the second DMD; and
detecting the location by using a driving time of the second DMD and the sensed light.

12. The method for obtaining the depth information of claim 10, wherein the first DMD comprises a plurality of element mirrors, and the irradiating the first line light comprises generating the first line light by simultaneously driving element mirrors arranged in one column among the plurality of element mirrors and irradiating the first line light to the object.

13. The method for obtaining the depth information of claim 10, wherein the second DMD comprises a plurality of element mirrors, and the reflecting the second line light comprises reflecting light corresponding to the second line light by driving the plurality of element mirrors one by one.

14. The method for obtaining the depth information of claim 10, wherein for a first period during which the first line light is irradiated to the object, all element mirrors of the second DMD are driven one by one to reflect light corresponding to the second line light.

15. The method for obtaining the depth information of claim 11, wherein the calculating the depth information calculates the depth information by using an angle at which the first line light is irradiated to the object and the detected location.

16. A depth information obtaining apparatus comprising:
a first digital micro-mirror device (DMD) that includes a plurality of first element mirrors and transmits a first line light to an object;
a second DMD that includes a plurality of second element mirrors, receives a second line light reflected from the object, and reflects light corresponding to the second line light;
a sensor that senses light reflected by the second DMD; and
a controller that controls the first line light to be generated by simultaneously driving element mirrors arranged in one column among the plurality of first element mirrors for a first period, and controls light corresponding to the second line light to be reflected to the sensor by driving the plurality of second element mirrors one by one,
wherein the controller calculates depth information of the object by using information with respect to light sensed by the sensor.

17. The depth information obtaining apparatus of claim 16, wherein the controller calculates the depth information by using an irradiation angle of the first line light to the object and a location at which the second line light is received at the second plurality of element mirrors.
